(19) United States
(12) Patent Application Publication
(10) Pub. No.: US 2025/0110226 A1
(43) Pub. Date: Apr. 3, 2025

(54) WAKE-UP SIGNAL IN MULTI-STATIC SENSING SYSTEM

(71) Applicant: QUALCOMM Incorporated, San Diego, CA (US)

(72) Inventors: Min HUANG, Beijing (CN); Jing DAI, Beijing (CN); Chao WEI, Beijing (CN); Hao XU, Beijing (CN)

(21) Appl. No.: 18/832,476

(22) PCT Filed: Mar. 7, 2022
(86) PCT No.: PCT/CN2022/079495

§ 371 Date: Jul. 23, 2024

(51) Int. Cl. G01S 13/00; H04W 24/08; H04W 24/10; H04W 72/231

(52) U.S. Cl. CPC G01S 13/003; H04W 24/08; H04W 24/10; H04W 72/231

(57) ABSTRACT

Disclosed are systems and techniques for wireless communications, such as for performing object detection using radio frequency (RF) sensing. In some aspects, a process of the disclosed technology can include steps for receiving a configuration message, wherein the configuration message comprises time-gap information associated with a control signal, receiving the control signal, wherein the control signal comprises radio resource information associated with a sensing signal, and receiving the sensing signal wherein the sensing signal comprises one or more reflected waveforms associated with a detected object. In some aspects, the process can further include steps for transmitting a measurement report corresponding with the detected object. Systems and machine-readable media are also provided.

### CROSS-REFERENCE TO RELATED APPLICATIONS

This application for patent is a 371 of international Patent Application PCT/CN2022/079495, filed Mar. 7, 2022, which is hereby incorporated by referenced in its entirety and for all purposes.

### FIELD OF THE DISCLOSURE

The present disclosure generally relates to radio frequency (RF) sensing. For example, aspects of the disclosure relate to systems and techniques for utilizing multi-static sensing techniques to perform object detection.

### BACKGROUND OF THE DISCLOSURE

In order to implement various telecommunications functions, electronic devices can include hardware and software components that are configured to transmit and receive radio frequency (RF) signals. For example, a wireless device can be configured to communicate via Wi-Fi, 5G/New Radio (NR), Bluetooth™, and/or ultra-wideband (UWB), among others. Utilizing wireless communication hardware, some electronic devices can be configured to perform object detection or sensing, such as by using multi-static object detection techniques.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing object detection using radio frequency (RF) sensing. According to at least one example, a method is provided for wireless communications. The method includes: receiving a configuration message, wherein the configuration message comprises time-gap information associated with a control signal; receiving the control signal, wherein the control signal comprises radio resource information associated with a sensing signal; receiving the sensing signal, wherein the sensing signal comprises one or more reflected waveforms associated with a detected object; and transmitting a measurement report corresponding with the detected object.

In another example, an apparatus for wireless communications is provided that includes at least one memory (e.g., configured to store data, such as virtual content data, one or more images, etc.) and one or more processors (e.g., implemented in circuitry) coupled to the at least one memory. The one or more processors are configured to and can: receive a configuration message, wherein the configuration message comprises time-gap information associated with a control signal; receive the control signal, wherein the control signal comprises radio resource information associated with a sensing signal; receive the sensing signal, wherein the sensing signal comprises one or more reflected waveforms associated with a detected object; and transmit a measurement report corresponding with the detected object.

In another example, a non-transitory computer-readable medium is provided that has stored thereon instructions that, when executed by one or more processors, cause the one or more processors to: receive a configuration message, wherein the configuration message comprises time-gap information associated with a control signal; receive the control signal, wherein the control signal comprises radio resource information associated with a sensing signal; receive the sensing signal, wherein the sensing signal comprises one or more reflected waveforms associated with a detected object; and transmit a measurement report corresponding with the detected object.

In another example, an apparatus for wireless communications is provided. The apparatus includes: means for receiving a configuration message, wherein the configuration message comprises time-gap information associated with a control signal; means for receiving the control signal, wherein the control signal comprises radio resource information associated with a sensing signal; means for receiving the sensing signal, wherein the sensing signal comprises one or more reflected waveforms associated with a detected object; and means for transmitting a measurement report corresponding with the detected object.

In some aspects, the apparatus is or is part of a wireless device, such as mobile device (e.g., a mobile telephone or so-called “smart phone” or other mobile device), a wearable device, an extended reality device (e.g., a virtual reality (VR) device, an augmented reality (AR) device, or a mixed reality (MR) device), an Internet-of-Things (IoT) device, a tablet, a personal computer, a laptop computer, a server computer, a wireless access point, a vehicle or component of a vehicle, or other any other device having an RF interface.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a computing system of an electronic device, in accordance with some examples;

FIG. 2 is a diagram illustrating an example of a wireless device utilizing radio frequency (RF) sensing techniques to detect an object presence based on an RF signature, in accordance with some examples;

FIG. 3A illustrates an example environment in which multi-static object sensing can be performed, in accordance with some examples;

FIG. 3B illustrates an example environment in which a UE wake-up approach can be used to facilitate multi-static object sensing, in accordance with some examples;

FIG. 4 illustrates an example of a control signal and a sensing signal that can be used to facilitate multi-static object detection, in accordance with some examples;

FIG. 5 illustrates an example signaling diagram of communications with a wireless device that is configured to perform multi-static object sensing, in accordance with some examples;

FIG. 6 illustrates an example environment in which multi-static object sensing can be performed by one or more UEs, such as using side-link communication, in accordance with some examples;

FIG. 7 illustrates an example environment in which multi-static object sensing can be performed by one or more base stations (e.g., a next-generation Node B (gNBs) or portion thereof), in accordance with some examples;

FIG. 8 illustrates an example process for performing multi-static object sensing, in accordance with some examples;

FIG. 9 is a block diagram illustrating an example of a wireless communication network, in accordance with some examples;

FIG. 10 is a diagram illustrating a design of abase station and a User Equipment (UE) device that enable transmission and processing of signals exchanged between the UE and the base station, in accordance with some examples;

FIG. 11 is a diagram illustrating an example of a disaggregated base station, in accordance with some examples; and

FIG. 12 is a block diagram illustrating an example of a computing system, in accordance with some examples.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Systems, apparatuses, processes (also referred to as methods), and computer-readable media (collectively referred to as “systems and techniques”) are described herein for performing radio frequency (RF) sensing of objects (e.g., sense object or target objects) in an environment. As discussed herein, several aspects of the disclosure involve the use of separate devices for transmitting RF waveforms/signals and for receiving the resulting object-reflected RF waveforms. These approaches can include bi-static or multi-static sensing approaches, which include the transmission of a sensing RF signal, such as a radar signal, (sensing signal) by a transmitting device, and reception of a resulting object-reflected RF signal (or sensing signal) by one or more different devices. These bi-static and/or multi-static approaches are collectively referred to as multi-static sensing herein.

Depending on the desired implementation, object sensing/detection using multi-static sensing approaches can be used in different contexts. For example, multi-static sensing techniques can be deployed for macro-sensing operations, including but not limited to meteorological monitoring applications, autonomous driving operations, dynamic mapping, low-altitude airspace management, and/or intruder detection, and the like. Similarly, multi-static sensing techniques may also be utilized for micro-sensing applications, including but not limited to gesture recognition, vital sign detection, high-resolution imaging, and the like.

Examples will be described herein using wireless network signals for performing object sensing operations. For example, in some cases, the systems and techniques can be implemented using 5G/New Radio (NR), such as using millimeter wave (mmWave) technology. However, it is understood that the described multi-static solutions are not limited to a particular radio configuration, for example, the systems and techniques can be implemented using other wireless technologies, such as Bluetooth™, and/or ultra-wideband (UWB), among others.

In some multi-static sensing setups, an RF sensing signal (also referred to as a sensing or sense signal) is transmitted by a transmitting device. The sensing signal may reflect off of one or more objects, resulting in one or more reflected versions of the sensing signal (referred to herein as object-reflected sensing signals). An object-reflected sensing signal may then be received by one or more (e.g., different) receiving devices, such as one or more User Equipment (UE) devices. Because it can be difficult to determine which UE will receive the sensing signal, in conventional multi-static network setups, each UE must perform constant monitoring to ensure that the sensing signal is received. Because the received sensing signals can be of relatively high-bandwidth, constant monitoring can require high power consumption, making such implementations non-optimal. Such a high-power monitoring can be problematic for certain devices, such as when mobile devices (e.g., UEs) are used to perform object sensing, that have limited power resources (e.g., based on battery limitations).

Aspects of the systems and techniques described herein provide solutions for reducing power consumption of sensing (or receiving) devices (e.g., UEs) configured to perform RF-based object sensing/detection in multi-static setups. In some examples, sensing UEs can be configured to operate in a low-power mode until a control signal is received. The control signal includes data, information, or properties indicating to a sensing UE that a subsequent sensing signal will be received. Based on the control signal, the sensing UE can initiate monitoring operations necessary to receive the sensing signal. For example, the sensing UE can be configured to ‘wake-up’ in response to the received control signal, and to initiate monitoring in time to receive the subsequent sensing signal (e.g., the sensing signal that has been reflected from a target object). As discussed in further detail below, the control signal can have a relatively low bandwidth as compared to the sensing signal. As such, the power expended to monitor for receipt of the control signal can be significantly less than the amount of power expended by the UE to monitor for (and receive) the sensing signal.

The UE can be pre-configured for receipt of the control signal (e.g., based on information conveyed in a prior-received configuration message). By way of example, the UE may receive a configuration message from a transmitting base station (e.g., gNB or portion thereof), for example, that is either in the same cell (or a different cell) as the UE. As discussed in further detail below, the configuration message can include radio resource information (e.g., in a preamble or control message), including type and/or format information for the subsequent control signal. Additionally, the configuration message can include time-gap information that indicates a period of time between receipt of the control signal and the subsequent sensing signal. In some aspects, the time-gap information can be used by the receiving UE, such as to determine when to initiate monitoring for the sensing signal. For instance, the time-gap can be configured to allow the sensing UE to have sufficient time to decode the control signal.

In some examples, the configuration message can be received as a Radio Resource Control (RRC) signal, a Medium Access Control (MAC) Control Element (CE), or Downlink Control Information (DCI), such as DCI received on a Physical Downlink Control Channel (PDCCH). In such examples, the configuration message may contain information specifying a Radio Network Temporary Identifier (RNTI). In some aspects, the RNTI is a group RNTI (G-RNTI). The RNTI (or G-RNTI) can be pre-configured by a base station (e.g., a gNB or portion thereof) and sent to a UE or group of UEs. In some cases, the RNTI (or G-RNTI) identifies specific UE devices that are to receive the subsequent control and/or sensing signals. For example, the RNTI (or G-RNTI) can be used to provide information to specifically select UEs (e.g., to enable the specific UEs to later receive/decode the control signal).

In some approaches, the control signal can be received as DCI (e.g., on a PDCCH). In some cases, the control signal may specify information to facilitate the transmission of a measurement report (e.g., by the UE to a base station, such as a gNB), which contains measurements based on the object-reflected sensing signal. For example, the control signal can include information specifying an uplink (UL) resource on which the measurement report can be transmitted by the UE. Depending on the desired implementation, the measurement report may include information identifying various characteristics about the sensed (target) object. In some approaches, the measurement report may identify kinematic characteristics of the sensed object, including but not limited to, distance, speed, velocity, and/or acceleration metrics of the sensed object. Additionally, the measurement report may report a Doppler frequency of the sensed/target object.

In some instances, the transmission of the control signal and/or the sensing signal (e.g., by a base station, such as a gNB), may not be optimally received by the sensing/receiving UE. In such instances, the sensing UE may communicate adjustment suggestions to the gNB using the measurement report. By way of example, the measurement report can include adjustment suggestions relating to transmission of the sensing signal by the gNB, and/or power control parameters relating to transmission of the control signal by the gNB.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures.

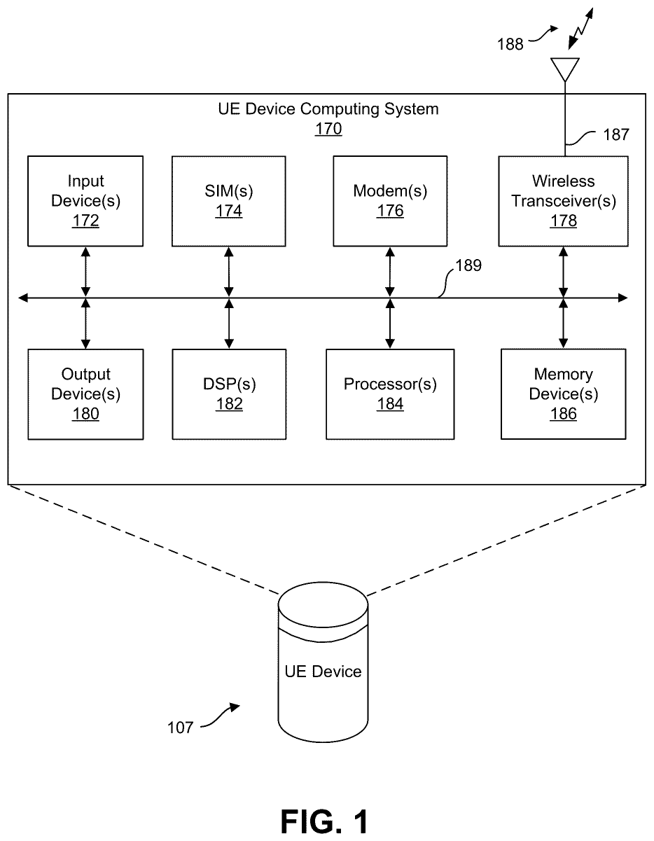

FIG. 1 illustrates an example of a computing system 170 of a user equipment (UE) device 107 (or UE 107). The UE 107 is an example of a device that can include hardware and software for the purpose of connecting and exchanging data with other devices and systems using computer networks (e.g., the internet). For example, the UE 107 can include a virtual assistant, smart speaker, smart television, smart appliance, mobile phone, router, tablet computer, laptop computer, tracking device, wearable device (e.g., a smart watch, glasses, an XR device, etc.), a vehicle (or a computing device of a vehicle), and/or another device used by a user to communicate over a wireless communications network. In some cases, the device can be referred to as a station (STA), such as when referring to a device configured to communicate using the Wi-Fi standard. In some cases, the device can be referred to as user equipment (UE), such as when referring to a device configured to communicate using 5G/New Radio (NR), Long-Term Evolution (LTE), or other telecommunication standard.

The computing system 170 includes software and hardware components that can be electrically or communicatively coupled via a bus 189 (or may otherwise be in communication, as appropriate). For example, the computing system 170 includes one or more processors 184. The one or more processors 184 can include one or more CPUs, ASICs, FPGAs, APs, GPUs, VPUs, NSPs, microcontrollers, dedicated hardware, any combination thereof, and/or other processing device/s and/or system/s. The bus 189 can be used by the one or more processors 184 to communicate between cores and/or with the one or more memory devices 186.

The computing system 170 may also include one or more memory devices 186, one or more digital signal processors (DSPs) 182, one or more subscriber identity modules (SIMs) 174, one or more modems 176, one or more wireless transceivers 178, one or more antennas 187, one or more input devices 172 (e.g., a camera, a mouse, a keyboard, a touch sensitive screen, a touch pad, a keypad, a microphone or a microphone array, and/or the like), and one or more output devices 180 (e.g., a display, a speaker, a printer, and/or the like).

The one or more wireless transceivers 178 can receive wireless signals (e.g., signal 188) via antenna 187 from one or more other devices, such as other user devices, network devices (e.g., base stations such as eNBs and/or gNBs, WiFi access points (APs) such as routers, range extenders or the like, etc.), cloud networks, and/or the like. In some examples, the computing system 170 can include multiple antennas or an antenna array that can facilitate simultaneous transmit and receive functionality. Antenna 187 can be an omnidirectional antenna such that RF signals can be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 178 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 188 into a baseband or intermediate frequency and can convert the RF signals to the digital domain.

In some cases, the computing system 170 can include a coding-decoding device (or CODEC) configured to encode and/or decode data transmitted and/or received using the one or more wireless transceivers 178. In some cases, the computing system 170 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 178.

The one or more SIMs 174 can each securely store an international mobile subscriber identity (IMSI) number and related key assigned to the user of the UE 107. The IMSI and key can be used to identify and authenticate the subscriber when accessing a network provided by a network service provider or operator associated with the one or more SIMs 174. The one or more modems 176 can modulate one or more signals to encode information for transmission using the one or more wireless transceivers 178. The one or more modems 176 can also demodulate signals received by the one or more wireless transceivers 178 in order to decode the transmitted information. In some examples, the one or more modems 176 can include a WiFi modem, a 4G (or LTE) modem, a 5G (or NR) modem, and/or other types of modems. The one or more modems 176 and the one or more wireless transceivers 178 can be used for communicating data for the one or more SIMs 174.

The computing system 170 can also include (and/or be in communication with) one or more non-transitory machine-readable storage media or storage devices (e.g., one or more memory devices 186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 186 and executed by the one or more processor(s) 184 and/or the one or more DSPs 182. The computing system 170 can also include software elements (e.g., located within the one or more memory devices 186), including, for example, an operating system, device drivers, executable libraries, and/or other code, such as one or more application programs, which may comprise computer programs implementing the functions provided by various embodiments, and/or may be designed to implement methods and/or configure systems, as described herein.

In some aspects, the UE 107 can include means for performing operations described herein. The means can include one or more of the components of the computing system 170. For example, the means for performing operations described herein may include one or more of input device(s) 172, SIM(s) 174, modems(s) 176, wireless transceiver(s) 178, output device(s) 180, DSP(s) 182, processors 184, memory device(s) 186, and/or antenna(s) 187.

In some aspects, UE 107 can include: means for identifying a first user of a first wireless device based on a first radio frequency (RF) signature associated with the first user; means for determining a disengagement of the first user from the first wireless device; and means for capturing content information associated with usage of the first wireless device by the first user in response to the disengagement. In some examples, the means for identifying can include the one or more wireless transceivers 178, the one or more modems 176, the one or more processors 184, the one or more DSPs 182, the one or more memory devices 186, any combination thereof, or other component(s) of the UE 107. In some examples, the means for determining can include the one or more processors 184, the one or more DSPs 182, the one or more memory devices 186, any combination thereof, or other component(s) of the UE 107. In some cases, the means for capturing can include the one or more processors 184, the one or more DSPs 182, the one or more memory devices 186, any combination thereof, or other component(s) of the UE 107.

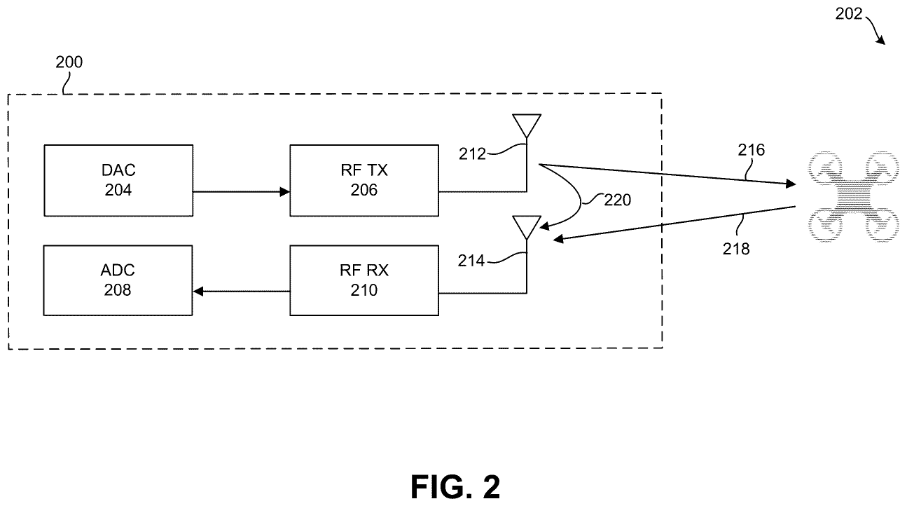

FIG. 2 is a diagram illustrating an example of a wireless device 200 that utilizes radio frequency (RF) sensing techniques to perform one or more functions, such as detecting/sensing presence of an object. The object 202 is depicted in FIG. 2 as an unmanned arial vehicle (UAV) for illustrative purposes. As described herein, several of the provided examples illustrate RF sensing techniques with respect to a particular type of object (e.g., the UAV in FIG. 2), however it is understood that such techniques may be applied to a variety of other objects, including users/people, vehicles, among others, without departing from the scope of the disclosed technology. As described herein, the RF sending techniques can be used to detect orientation characteristics of the object 202, detecting kinematic characteristics of the object 202, or any combination thereof, and/or perform other functions. In some examples, the wireless device 200 can be the UE 107, such as a mobile phone, a tablet computer, a wearable device, or other device that includes at least one RF interface. In some examples, the wireless device 200 can be a device that provides connectivity for a user device (e.g., for UE 107), such as a wireless access point (AP), a base station (e.g., a gNB, eNB, etc.), or other device that includes at least one RF interface.

In some aspects, wireless device 200 can include one or more components for transmitting an RF signal. Wireless device 200 can include a digital-to-analog converter (DAC) 204 that is capable of receiving a digital signal or waveform (e.g., from a microprocessor, not illustrated) and converting the signal or waveform to an analog waveform. The analog signal that is the output of DAC 204 can be provided to RF transmitter 206. The RF transmitter 206 can be a Wi-Fi transmitter, a 5G/NR transmitter, a Bluetooth™ transmitter, or any other transmitter capable of transmitting an RF signal.

RF transmitter 206 can be coupled to one or more transmitting antennas such as TX antenna 212. In some examples, TX antenna 212 can be an omnidirectional antenna that is capable of transmitting an RF signal in all directions. For example, TX antenna 212 can be an omnidirectional Wi-Fi antenna that can radiate Wi-Fi signals (e.g., 2.4 GHz, 5 GHz, 6 GHz, etc.) in a 360-degree radiation pattern. In another example, TX antenna 212 can be a directional antenna that transmits an RF signal in a particular direction.

In some examples, wireless device 200 can also include one or more components for receiving an RF signal. For example, the receiver lineup in wireless device 200 can include one or more receiving antennas such as RX antenna 214. In some examples, RX antenna 214 can be an omnidirectional antenna capable of receiving RF signals from multiple directions. In other examples, RX antenna 214 can be a directional antenna that is configured to receive signals from a particular direction. In further examples, both TX antenna 212 and RX antenna 214 can include multiple antennas (e.g., elements) configured as an antenna array.

Wireless device 200 can also include an RF receiver 210 that is coupled to RX antenna 214. The RF receiver 210 can include one or more hardware components for receiving an RF waveform such as a Wi-Fi signal, a Bluetooth™ signal, a 5G/NR signal, or any other RF signal (e.g., a configuration signal and/or a sensing signal, as disclosed herein). The output of RF receiver 210 can be coupled to an analog-to-digital converter (ADC) 208. ADC 208 can be configured to convert the received analog RF waveform into a digital waveform that can be provided to a processor such as a digital signal processor (not illustrated).

In one example, wireless device 200 can implement RF sensing techniques by causing TX waveform 216 to be transmitted from TX antenna 212. Although TX waveform 216 is illustrated as a single line, in some cases, TX waveform 216 can be transmitted in all directions by an omnidirectional TX antenna 212. In one example, TX waveform 216 can be a Wi-Fi waveform that is transmitted by a Wi-Fi transmitter in wireless device 200. In some cases, TX waveform 216 can correspond to a Wi-Fi waveform that is transmitted at or near the same time as a Wi-Fi data communication signal or a Wi-Fi control function signal (e.g., a beacon transmission). In some examples, TX waveform 216 can be transmitted using the same or a similar frequency resource as a Wi-Fi data communication signal or a Wi-Fi control function signal (e.g., a beacon transmission). In some aspects, TX waveform 216 can correspond to a Wi-Fi waveform that is transmitted separately from a Wi-Fi data communication signal and/or a Wi-Fi control signal (e.g., TX waveform 216 can be transmitted at different times and/or using a different frequency resource).

In some examples, TX waveform 216 can correspond to a 5G NR waveform that is transmitted at or near the same time as a 5G NR data communication signal or a 5G NR control function signal. In some examples, TX waveform 216 can be transmitted using the same or a similar frequency resource as a 5G NR data communication signal or a 5G NR control function signal. In some aspects, TX waveform 216 can correspond to a 5G NR waveform that is transmitted separately from a 5G NR data communication signal and/or a 5G NR control signal (e.g., TX waveform 216 can be transmitted at different times and/or using a different frequency resource).

In some aspects, one or more parameters associated with TX waveform 216 can be modified that may be used to increase or decrease RF sensing resolution. The parameters may include frequency, bandwidth, number of spatial streams, the number of antennas configured to transmit TX waveform 216, the number of antennas configured to receive a reflected RF signal corresponding to TX waveform 216, the number of spatial links (e.g., number of spatial streams multiplied by number of antennas configured to receive an RF signal), the sampling rate, or any combination thereof.

In further examples, TX waveform 216 can be implemented to have a sequence that has perfect or almost perfect autocorrelation properties. For instance, TX waveform 216 can include single carrier Zadoff sequences or can include symbols that are similar to orthogonal frequency-division multiplexing (OFDM) Long Training Field (LTF) symbols. In some cases, TX waveform 216 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some aspects, wireless device 200 can further implement RF sensing techniques by performing concurrent transmit and receive functions. For example, wireless device 200 can enable its RF receiver 210 to receive at or near the same time as it enables RF transmitter 206 to transmit TX waveform 216. In some examples, transmission of a sequence or pattern that is included in TX waveform 216 can be repeated continuously such that the sequence is transmitted a certain number of times or for a certain duration of time. In some examples, repeating a pattern in the transmission of TX waveform 216 can be used to avoid missing the reception of any reflected signals if RF receiver 210 is enabled after RF transmitter 206. In one example implementation, TX waveform 216 can include a sequence having a sequence length L that is transmitted two or more times, which can allow RF receiver 210 to be enabled at a time less than or equal to L in order to receive reflections corresponding to the entire sequence without missing any information.

By implementing simultaneous transmit and receive functionality, wireless device 200 can receive any signals that correspond to TX waveform 216. For example, wireless device 200 can receive signals that are reflected from objects or people that are within range of TX waveform 216, such as RX waveform 218 reflected from object 202. Wireless device 200 can also receive leakage signals (e.g., TX leakage signal 220) that are coupled directly from TX antenna 212 to RX antenna 214 without reflecting from any objects. For example, leakage signals can include signals that are transferred from a transmitter antenna (e.g., TX antenna 212) on a wireless device to a receive antenna (e.g., RX antenna 214) on the wireless device without reflecting from any objects. In some cases, RX waveform 218 can include multiple sequences that correspond to multiple copies of a sequence that are included in TX waveform 216. In some examples, wireless device 200 can combine the multiple sequences that are received by RF receiver 210 to improve the signal to noise ratio (SNR).

Wireless device 200 can further implement RF sensing techniques by obtaining RF sensing data associated with each of the received signals corresponding to TX waveform 216. In some examples, the RF sensing data can include channel state information (CSI) data relating to the direct paths (e.g., leakage signal 220) of TX waveform 216 together with data relating to the reflected paths (e.g., RX waveform 218) that correspond to TX waveform 216.

In some aspects, RF sensing data (e.g., CSI data) can include information that can be used to determine the manner in which an RF signal (e.g., TX waveform 216) propagates from RF transmitter 206 to RF receiver 210. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used to calculate distances and angles of arrival that correspond to reflected waveforms, such as RX waveform 218. In further examples, RF sensing data can also be used to detect physical characteristics, detect motion, determine location, detect changes in location or motion patterns, obtain channel estimation, or any combination thereof. In some cases, the distance and angle of arrival of the reflected signals can be used to identify the size, position, movement, or orientation of users in the surrounding environment (e.g., object 202) in order to detect user/object presence/proximity. In some examples, RF sensing data can be used to determine an RF signature associated with object 202. In some instance, the RF signature can be based on one or more physical attributes of user determined based on the RF sensing data.

Wireless device 200 can calculate distances and angles of arrival corresponding to reflected waveforms (e.g., the distance and angle of arrival corresponding to RX waveform 218) by utilizing signal processing, machine learning algorithms, using any other suitable technique, or any combination thereof. In other examples, wireless device 200 can transmit or send the RF sensing data to another computing device, such as a server, that can perform the calculations to obtain the distance and angle of arrival corresponding to RX waveform 218 or other reflected waveforms.

In one example, the distance of RX waveform 218 can be calculated by measuring the difference in time from reception of the leakage signal to the reception of the reflected signals. For example, wireless device 200 can determine a baseline distance of zero that is based on the difference from the time the wireless device 200 transmits TX waveform 216 to the time it receives leakage signal 220 (e.g., propagation delay). Wireless device 200 can then determine a distance associated with RX waveform 218 based on the difference from the time the wireless device 200 transmits TX waveform 216 to the time it receives RX waveform 218 (e.g., time of flight), which can then be adjusted according to the propagation delay associated with leakage signal 220. In doing so, wireless device 200 can determine the distance traveled by RX waveform 218 which can be used to determine the presence and movement of an object that caused the reflection.

In further examples, the angle of arrival of RX waveform 218 can be calculated by measuring the time difference of arrival of RX waveform 218 between individual elements of a receive antenna array, such as antenna 214. In some examples, the time difference of arrival can be calculated by measuring the difference in received phase at each element in the receive antenna array.

In some cases, the distance and the angle of arrival of RX waveform 218 can be used to determine the distance between wireless device 200 and object 202 as well as the position of object 202 relative to wireless device 200. The distance and the angle of arrival of RX waveform 218 can also be used to determine presence, movement, proximity, attention, identity, or any combination thereof, of object 202. For example, wireless device 200 can utilize the calculated distance and angle of arrival corresponding to RX waveform 218 to determine that object 202 is moving towards wireless device 200.

As noted above, wireless device 200 can include a mobile device (e.g., a mobile device such as a smartphone), a laptop, a tablet, an Internet-of-Things (IoT) device, a computing component or system of a vehicle or vessel (e.g., an automobile, an aerial vehicle such as an airplane, unmanned aerial vehicle (UAV) or drone, a boat, or other vehicle or vessel), an extended reality (XR) device (e.g., a virtual reality (VR), augmented reality (AR), or mixed reality (MR) device), or other types of device. In some examples, wireless device 200 can be configured to obtain device location data and device orientation data together with the RF sensing data. In some instances, device location data and device orientation data can be used to determine or adjust the distance and angle of arrival of a reflected signal such as RX waveform 218. For example, wireless device 200 may be set on a table facing the ceiling as object 202 moves towards it during the RF sensing process. In this instance, wireless device 200 can use its location data and orientation data together with the RF sensing data to determine the direction that the object 202 is moving.

In some examples, device position data can be gathered by wireless device 200 using techniques that include round trip time (RTT) measurements, passive positioning, angle of arrival, received signal strength indicator (RSSI), CSI data, using any other suitable technique, or any combination thereof. In further examples, device orientation data can be obtained from electronic sensors on the wireless device 200, such as a gyroscope, an accelerometer, a compass, a magnetometer, a barometer, any other suitable sensor, or any combination thereof.

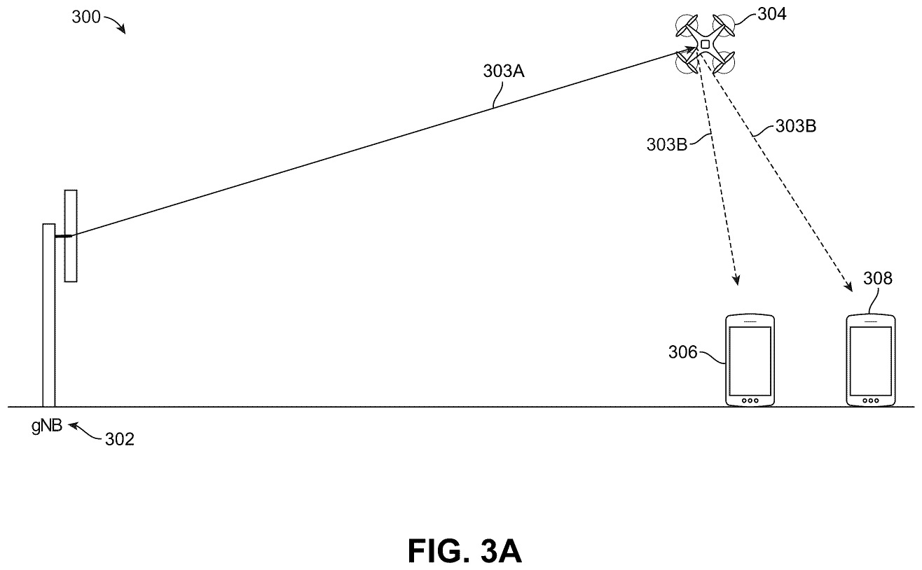

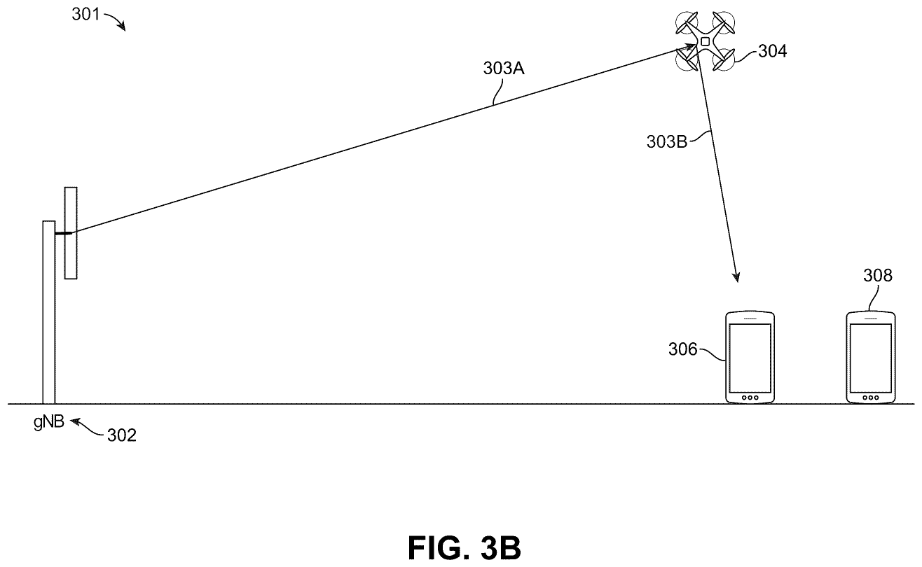

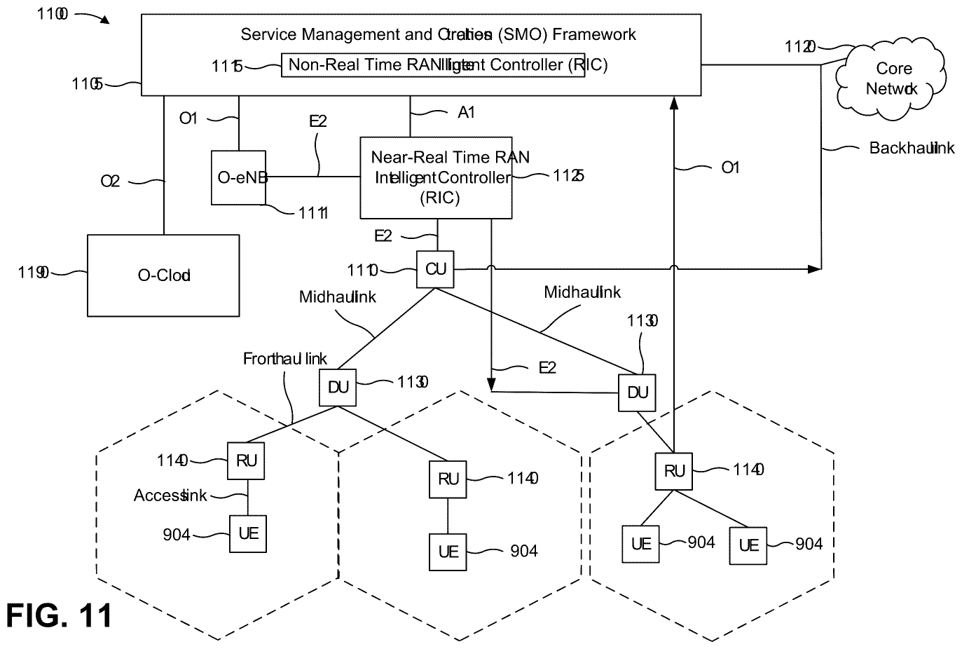

FIG. 3A illustrates an example environment 300 in which multi-static object sensing can be performed. Environment 300 includes a base station (e.g., gNB 302), as well as receiving wireless devices (UEs), including sensing UE 306 and sensing UE 308. The UEs (e.g., UE 306, 308) can be configured to perform RF sensing to detect/identify object 304. For instance, the UEs (e.g., UEs 306, 308) can be configured to continuously or periodically monitor for signals. In one example, the UE 306 and/or the UE 308 can perform such monitoring of signals to ensure that the UE 306, 308 receives a sensing signal that is transmitted by gNB 302 (as sensing signal 303A) and reflected by object 304 (as sensing signal 303B). While a gNB 302 is shown in FIG. 3A (and FIG. 3B) as an illustrative example of a network entity, other network entities can be used for the RF sensing approaches described herein, such as a location server (e.g., a location management function (LMF), a roadside unit (RSU) configured to communicate using cellular vehicle-to-everything (C-V2X) communications, another type of network entity, or a combination of network entities. The network entity (e.g., location server, gNB 302, etc.) in some cases may have monolithic architecture or in other cases may have a disaggregated architecture (e.g., including one or more of a central unit (CU), a distributed unit (DU), a radio unit (RU), a Near-Real Time (Near-RT) RAN Intelligent Controller (RIC), or a Non-Real Time (Non-RT) RIC, described in further detail below with respect to FIG. 11).

In conventional sensing approaches, it can be difficult to know which (or if any) of the UEs (306, 308) are positioned to receive reflected signals, such as the reflected sensing signal 303B. For example, due to the irregular shape of the sensed object 304, it can be difficult to determine which UE (e.g., UE 306, 308) is positioned to receive the reflected sensing signal 303B. Using such conventional approaches, UEs (e.g., UE 306, 308) must actively or continuously perform monitoring to ensure receipt of sensing signal 303B.

Aspects of the disclosed technology provide solutions for reducing power consumption of UEs (e.g., UEs 306, 308) needed to perform continuous active monitoring for a sensing signal (e.g., sensing signal associated with transmitted sensing signal 303A and reflected sensing signal 303B), such as in multi-static setups as illustrated in FIG. 3A. In some approaches, sensing UEs 306, 308 can be configured to operate in a low-power mode until a control signal (not illustrated) is received. The control signal can be used to indicate to the UEs 306, 308 if (and in some cases when) the sensing signal (e.g., reflected sensing signal 303B) will be received. As discussed in further detail below, the control signal can have a relatively low bandwidth as compared to the sensing signal, which can have a relatively high bandwidth (e.g., 100 MHz-1 GHz) needed to make precise distance measurements. As such, the power expended to monitor for receipt of the control signal can be significantly less than the amount of power expended by the UE to monitor for (and receive) the sensing signal.

FIG. 3B illustrates an example environment 301 in which a UE wake-up approach can be used to facilitate multi-static object sensing. The approach illustrated in FIG. 3B can be performed to reduce power expenditure needed by UEs 306, 306 to monitor for one or more sensing signals (e.g., the reflected sensing signal 303B). In such approaches, UEs 306, 308 can be pre-configured for receipt of a control signal (not illustrated), such as based on information conveyed in a prior-received configuration message. For instance, the gNB 302 (or other network entity) may generate the configuration message and transmit the configuration message to the UE 306 and/or UE 308 or to another network entity that then transmits or relays the configuration message to the UE 306 and/or UE 308. In one example, UEs 306, 308 may first receive a configuration message from gNB 302, for example, that is either in the same cell (or a different cell) as UEs 306, 308. The configuration message can include radio resource information (e.g., in a preamble or control message), including type and/or format information for the subsequent control signal. In some aspects, the preamble sequences in the configuration message can be configured by the transmitting gNB (e.g., gNB 302). In such approaches, the choice of preamble sequences can be used to represent information, such as information relating to a particular format of the following sensing signal.

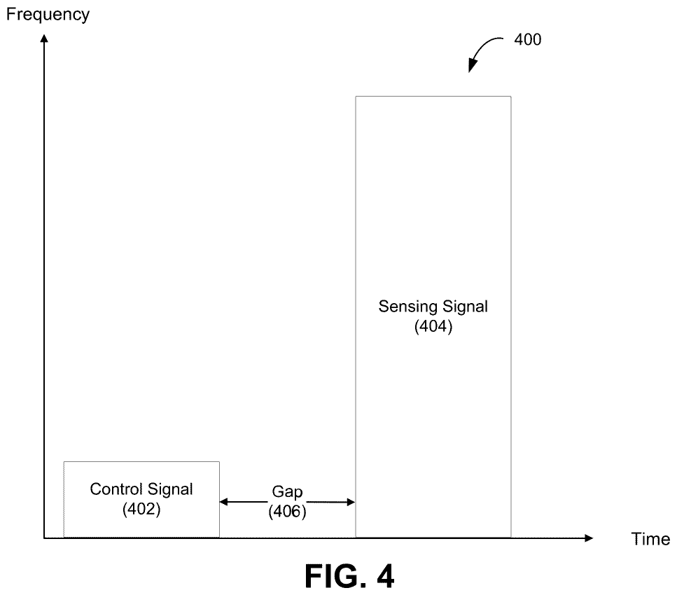

Additionally, the configuration message can include time-gap information that indicates a period of time between receipt of the control signal and the subsequent sensing signal (e.g., reflected sensing signal 303B). As discussed in further detail with respect to FIG. 4, the time-gap (shown as time-gap 406 in FIG. 4) can specify a time duration between the control signal (shown as control signal 402 in FIG. 4) and the sensing signal (shown as sensing signal 404 in FIG. 4, which may correspond to reflected sensing signal 303B of FIG. 3A and/or FIG. 3B in some cases). In some aspects, the time-gap can be configured to be a duration small enough to ensure that the control signal and the sensing signal (e.g., sensing signal 303A and/or 303B) are reflected by the same object (e.g., object 304). In some aspects, the transmission (tx) beam of the control signal can be the same as the beam selected for transmission of the sensing signal.

The time-gap information can be used by the receiving UE (e.g., UE 306) to determine when to initiate monitoring for the sensing signal. As such, the control signal can function as a ‘wake up’ signal that causes the selected UE (e.g., UE 306) to initiate monitoring for sensing signal. For instance, referring to the example of FIG. 3B for illustrative purposes, UE 306 represents a UE that receives the control signal and thus is properly configured to receive sensing signal (e.g., reflected sensing signal 303B), whereas UE 308 represents a UE that does not receive the control signal and thus is not configured for receipt of sensing signal (e.g., reflected sensing signal 303B), and therefore does not initiate monitoring.

Depending on the desired implementation, the configuration message can be received as RRC signaling, MAC CE, or Downlink Control Information (DCI) (e.g., from gNB 302, a portion thereof such as a CU, DU, RU, etc., or from another device or network entity). In such instances, the configuration message may contain information specifying a group Radio Network Temporary Identifier (G-RNTI). For example, the G-RNTI may include information identifying specific UEs (e.g., UE 306) selected to receive the subsequent control and/or sensing signal (e.g., reflected sensing signal 303B). In some examples, the content of the DCI may indicate a format of the following sensing signal (e.g., reflected sensing signal 303B), such as the waveform type, time-frequency domain resource information, periodicity information, reference signal sequence information, and/or mapping method information, etc.

In some approaches, the control signal can be received as DCI (e.g., from gNB 302, a portion thereof such as a CU, DU, RU, etc., or from another device or network entity). The control signal may also specify information to facilitate the transmission of a measurement report (not illustrated) by the receiving UE 306 (e.g., transmission of the measurement report to the gNB 302, a portion thereof, or from another device or network entity). As discussed in further detail below, the measurement report can include measurements performed by UE 306 based on the sensing signal (e.g., reflected sensing signal 303B) that is reflected by object 304. By way of example, the measurement report may identify characteristics of the object 304, including but not limited to, distance, speed, velocity, and/or acceleration metrics of the sensed object 304, and/or Doppler frequency characters of the object 304. In some instances, the measurement report can be transmitted by the UE 306 to the gNB 302 in a manner specified by UL resource information specified by the control signal.

In some instances, the transmission of the control signal and/or the sensing signal (e.g., by a base station or gNB), may not be optimally received by the sensing/receiving UE. In such instances, the sensing UE may communicate adjustment suggestions to the gNB using the measurement report. By way of example, the measurement report can include adjustment suggestions relating to transmission of the sensing signal by the gNB, and/or power control parameters relating to transmission of the control signal by the gNB. The transmission power of the control signal can be based on the target-maximum sensing signal propagation distance, and/or the radar cross section (RCS) value associated with the target/sensed object.

By way of example, because the gNB (e.g., gNB 302) does not know the position of the target/sensed object 304, and/or the position of the sensing UE (e.g., UE 306), the transmission power can be determined based on the possible maximum transmit/receive (Tx-Rx) propagation distance. In some aspects, the transmission power of the control signal (denoted as Pₜ) can be configured to satisfy the relationship of equation (1):

$$\frac{σ {P}_{t} {G}_{t} {G}_{r} {λ}^{2}}{{( 4 π )}^{3} {d}_{1}^{2} {d}_{2}^{2}} \geq {S}_{r} \qquad ( 1 )$$

where d₁ and d₂ are the maximum sensing distances between gNB 302 and target object 304, or between target object 304 and sensing UE 306, respectively. These two values can be obtained based on the cell deployment and sensing requirement. In turn, Gₜ and Gᵣ can represent the Tx gain (containing Tx antenna gain and Tx beamforming gain) or the Rx gain (containing Rx antenna gain and Rx beamforming gain), respectively. λ is the wavelength of the carrier on which the sensing-associated control signal is transmitted. Sᵣ is a threshold value (or Rx sensitivity) of the sensing-associated control signal meaning when the power of received signal is not smaller than it, the receiver (e.g., sensing UE 306) can decode this signal, and σ is the reflection size of object 304, which is denoted as RCS.

In some aspects, the sensing UE 306 may facilitate configuration of the control signal transmit power by reporting values Gᵣ and Sᵣ to the gNB 302. For example, the sensing UE 306 may communicate suggested adjustments, based on a previously received control signal, in the measurement report provided back to gNB 302. Alternatively, in some approaches, values for Gᵣ and/or Sᵣ may be predetermined, such as based on a regulation or standard.

FIG. 4 illustrates is a diagram 400 illustrating an example of a control signal 402 and a sensing signal 404 that can be used to facilitate multi-static object detection. As discussed above, the receiving/sensing device (e.g., UE 306 discussed above with respect to FIG. 3B) can be configured to ‘wake-up’ or initiate monitoring based on the receipt of a control signal 402. The control signal 402 and/or a previously received configuration message may be used to specify a duration associated with gap 406 (also referred to as a time-gap). For example, the duration associated with the gap 406 may indicate a time duration between transmission of the control signal 402 and subsequent sensing signal 404. The time-gap 406 can be used by the receiving UE to determine when to initiate monitoring for the sensing signal 404. As such, the time-gap can be configured to allow the sensing UE to have sufficient time to decode the control signal 402 (e.g., before decoding or processing the sensing signal).

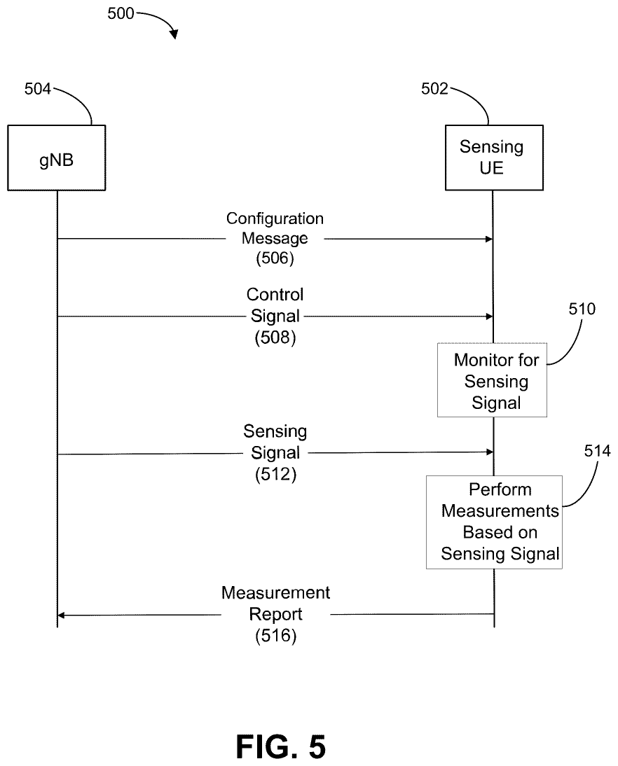

FIG. 5 illustrates an example signaling diagram 500 of communications with a wireless device (e.g., sensing UE 502) that is configured to perform multi-static object sensing. In the setup illustrated in the example of FIG. 5, a gNB (e.g., gNB 504) is used to facilitate multi-static object sensing/detection; however, it is understood that a variety of additional (or different) wireless devices may be implemented in place of gNB 504, without departing from the scope of the disclosed technology.

In operation, gNB can transmit a configuration message 506 to sensing UE 502, such as to pre-configure the UE 502 for receipt of subsequent control/sensing signals. Depending on the implementation, gNB 504 may be in the same cell (or a different cell) as UE 502. The configuration message 506 can include radio resource information (e.g., in a preamble or control message), including type and/or format information for a subsequent control signal. In some aspects, the choice of preamble sequences can be used to represent a particular format of a later transmitted sensing signal.

The configuration message can additionally include time-gap information indicating a period of time between receipt of the control signal and the subsequent sensing signal. As discussed above with respect to FIG. 4, the time-gap information can be used by the receiving UE (sensing UE 502) to determine when to initiate monitoring for the sensing signal. For instance, the time-gap can be configured to allow the sensing UE to have sufficient time to decode the control signal 402 (e.g., before decoding or processing the sensing signal 404).

The configuration message can be received as RRC signaling, MAC CE, or Downlink Control Information (DCI). In such instances, the configuration message may contain information specifying a (group) Radio Network Temporary Identifier, such as to identify specific UEs that are intended to receive subsequent control and/or sensing signals. For example, the RNTI (or group RNTI) can be used to provide information to specifically select UEs, such as to enable the UEs to later receive/decode a control signal.

The gNB 504 can then transmit a control signal 508 to sensing UE 502. Using the time-gap information provided in the configuration message 506, the sensing UE 502 can use the control signal 508 to determine when to initiate monitoring for a sensing signal. As such, the control signal can function as a ‘wake up’ signal that causes the selected UE (e.g., sensing UE 502) to initiate monitoring for sensing signal (at block 510).

The control signal can be received as DCI, and may also specify information to facilitate the later transmission of a measurement report (e.g., by the UE 502 to a gNB 504), as discussed below. For example, the control signal can include information specifying an uplink (UL) resource on which the sensing UE 502 can communicate back to the gNB 504.

After successful receipt of the control signal 508, the sensing UE 502 can initiate monitoring for a subsequent sensing signal 512. The sensing signal 512 can include reflected RF waveforms, for example, that have been reflected off of a sensed/detected object, such as object 304, discussed above with respect to FIG. 3B. In some aspects, if the sensing UE 502 has multiple receiving (Rx) antennas, the sensing UE 502 can use the same/identical Rx beam (e.g., a Rx antenna panel and Rx beam weight) to receive the control signal 508 and to receive the sensing signal 512.

Based on the received sensing signal 512, the sensing UE 502 can perform measurements at block 514, such as to identify various characteristics associated with a sensed object (not illustrated). By way of example, measurements may include various metrics for the sensed object, including but not limited to, distance, speed, velocity, and/or acceleration metrics of the sensed object, and/or Doppler frequency characters associated with the object.

Once measurements have been performed based on the sensing signal 512, the sensing UE can communicate the measurements back to the gNB 504 (e.g., in a measurement report 516). In some instances, the measurement report 516 can be transmitted by the UE 502 to the gNB 504 in a manner specified by UL resource information indicated in the control signal 508. As discussed above, communication of the measurement report 516 can be based on UL resource information provided by the gNB 504 to the sensing UE 502 (e.g., as DCI).

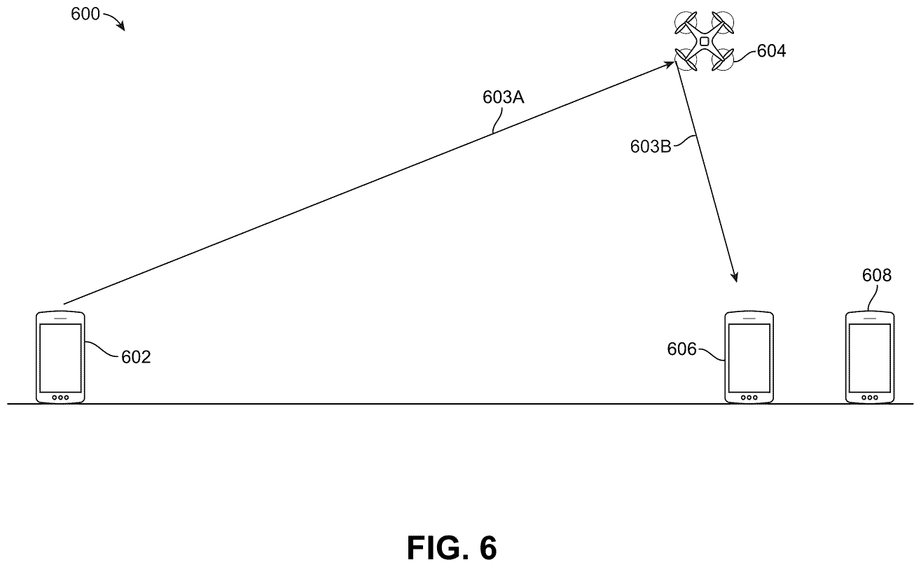

FIG. 6 illustrates an example environment 600 in which multi-static object sensing can be performed by multiple UEs, such as using side-link communications. In the example of FIG. 6, a transmitting UE 602 can configure one or more receiving UE devices (606, 608). In such instances, the control signal can be a preamble or SCI message. In such instances, all sensing UEs (e.g., 606 and 608) can monitor for the control signal on the sidelink, however only UEs that can receive the control signal (e.g., UE 606) can detect the sensing signal 603.

In the example of FIG. 6, a control signal (not illustrated) is initially received by receiving UE 606. Subsequently, a sensing signal 603A is received by receiving UE 606 (e.g., as reflected sensing signal 603B) from object 604. In contrast, receiving UE 608 does not receive the control signal, for example, because the control signal is not reflected by object 604, in the direction of UE 608.

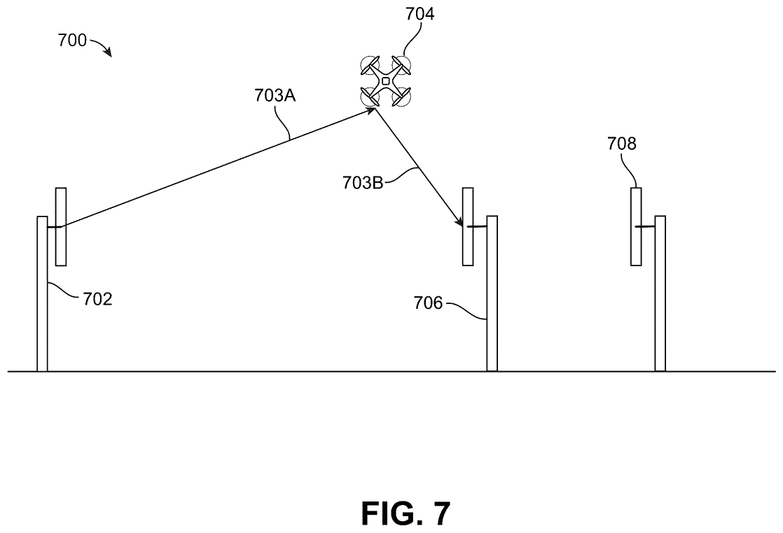

FIG. 7 illustrates an example environment 700 in which multi-static object sensing can be performed by one or more base stations. In the example of FIG. 7, a transmitting gNB 702 can configure one or more receiving gNB devices (706, 708). In such instances, the control signal can be transmitted in the inter-gNB air interface prior to the sensing signal. In such instances, all sensing gNBs (e.g., 706 and 708) can monitor for the control signal on the inter-gNB air interface, however only gNBs that can receive the control signal (e.g., gNB 706) can detect the sensing signal 703 (e.g., reflected sensing signal 703B based on transmission of sensing signal 703A).

In the example of FIG. 7, a control signal (not illustrated) is initially received by receiving gNB 706. Subsequently, the sensing signal 703A is received by receiving gNB 706 (e.g., as reflected sensing signal 703B) from object 704. In contrast, receiving gNB 708 does not receive the control signal, for example, because the control signal is not reflected by object 704 in the direction of gNB 708.

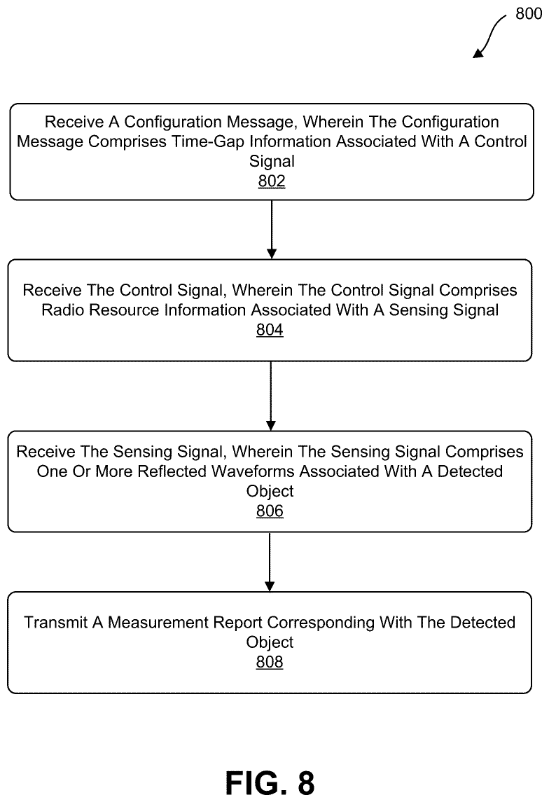

FIG. 8 illustrates an example process 800 for performing multi-static object sensing. At step 802, the process 800 includes receiving a configuration message, wherein the configuration message comprises time-gap information associated with a control signal. As discussed above, the time-gap information can indicate a period of time between receipt of the control signal and the subsequent sensing signal. In some aspects, the time-gap information can be used by the receiving UE, such as to determine when to initiate monitoring for the sensing signal. For instance, the time-gap can be configured to allow the sensing UE to have sufficient time to decode the control signal.

Depending on the desired implementation, the configuration message can be received as Downlink Control Information (DCI) (e.g., from a gNB, a portion thereof such as a CU, DU, RU etc., or from another device). In such instances, the configuration message may contain information specifying a group Radio Network Temporary Identifier (G-RNTI), such as to identify specific UEs (e.g., UE 306) selected to receive the subsequent control and/or sensing signal. In some examples, the content of the DCI may indicate a format of the following sensing signal, such as the waveform type, time-frequency domain resource information, periodicity information, reference signal sequence information, and/or mapping method information, etc.

At step 804, the process 800 includes receiving the control signal, wherein the control signal includes radio resource information associated with a sensing signal. As discussed above, the control signal can be received as DCI (e.g., from a gNB or portion thereof, or from another device or network entity). The control signal may also specify information to facilitate the transmission of a measurement report (e.g., by the receiving UE to the gNB), which contains measurements based on the object-reflected sensing signal. For example, the control signal can include information specifying an uplink (UL) resource on which the measurement report can be transmitted by the UE.

At step 806, the process 800 includes receiving the sensing signal, wherein the sensing signal includes one or more reflected waveforms associated with a detected/sensed object.

At step 808, the process 800 includes transmitting a measurement report corresponding with the detected object. Depending on the desired implementation, the measurement report may include information identifying various characteristics about the sensed (target) object. In some approaches, the measurement report may identify kinematic characteristics of the sensed object, including but not limited to, distance, speed, velocity, and/or acceleration metrics of the sensed object. Additionally, the measurement report may report a Doppler frequency of the sensed/target object.

The transmission of the control signal and/or the sensing signal (e.g., by a base station or gNB), may not be optimally received by the sensing/receiving UE. In such instances, the sensing UE may communicate adjustment suggestions to the gNB using the measurement report. By way of example, the measurement report can include adjustment suggestions relating to transmission of the sensing signal by the gNB, and/or power control parameters relating to transmission of the control signal by the gNB.

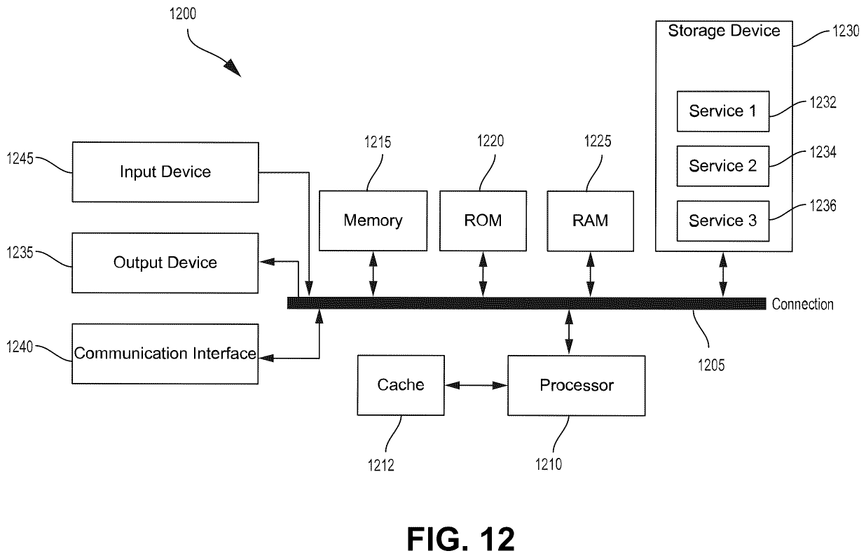

The processes described herein (e.g., process 800 and/or other process described herein) may be performed by a computing device or apparatus (e.g., a UE). In one example, the process 800 can be performed by the UE 107 of FIG. 1. In another example, the process 800 can be performed by a computing device with the computing system 1200 shown in FIG. 12. For instance, a computing device with the computing architecture shown in FIG. 12 can include the components of the UE 107 of FIG. 1 and can implement the operations of FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

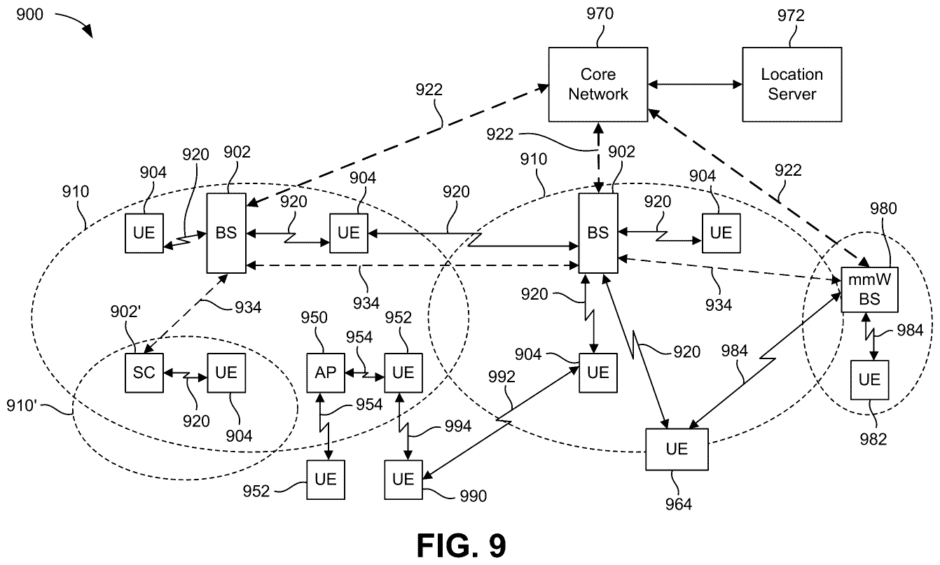

FIG. 9 illustrates an example of a wireless communications system 900 that can be used to communicate signals according to the systems and techniques described herein. The wireless communications system 900 (which may also be referred to as a wireless wide area network (WWAN)) can include various base stations 902 and various UEs 904. In some aspects, the base stations 902 may also be referred to as “network entities” or “network nodes.” One or more of the base stations 902 can be implemented in an aggregated or monolithic base station architecture. Additionally, or alternatively, one or more of the base stations 902 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 902 can include macro cell base stations (high power cellular base stations) and/or small cell base stations (low power cellular base stations). In an aspect, the macro cell base station may include eNBs and/or ng-eNBs where the wireless communications system 900 corresponds to a long term evolution (LTE) network, or gNBs where the wireless communications system 900 corresponds to a NR network, or a combination of both, and the small cell base stations may include femtocells, picocells, microcells, etc.

The base stations 902 may collectively form a RAN and interface with a core network 970 (e.g., an evolved packet core (EPC) or a 5G core (5GC)) through backhaul links 922, and through the core network 970 to one or more location servers 972 (which may be part of core network 970 or may be external to core network 970). In addition to other functions, the base stations 902 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 902 may communicate with each other directly or indirectly (e.g., through the EPC or 5GC) over backhaul links 934, which may be wired and/or wireless.

The base stations 902 may wirelessly communicate with the UEs 904. Each of the base stations 902 may provide communication coverage for a respective geographic coverage area 910. In an aspect, one or more cells may be supported by a base station 902 in each coverage area 910. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 910.

While neighboring macro cell base station 902 geographic coverage areas 910 may partially overlap (e.g., in a handover region), some of the geographic coverage areas 910 may be substantially overlapped by a larger geographic coverage area 910. For example, a small cell base station 902′ may have a coverage area 910′ that substantially overlaps with the coverage area 910 of one or more macro cell base stations 902. A network that includes both small cell and macro cell base stations may be known as a heterogeneous network. A heterogeneous network may also include home eNBs (HeNBs), which may provide service to a restricted group known as a closed subscriber group (CSG).

The communication links 920 between the base stations 902 and the UEs 904 may include uplink (also referred to as reverse link) transmissions from a UE 904 to a base station 902 and/or downlink (also referred to as forward link) transmissions from a base station 902 to a UE 904. The communication links 920 may use MIMO antenna technology, including spatial multiplexing, beamforming, and/or transmit diversity. The communication links 920 may be through one or more carrier frequencies. Allocation of carriers may be asymmetric with respect to downlink and uplink (e.g., more or less carriers may be allocated for downlink than for uplink).

The wireless communications system 900 may further include a WLAN AP 950 in communication with WLAN stations (STAs) 952 via communication links 954 in an unlicensed frequency spectrum (e.g., 5 Gigahertz (GHz)). When communicating in an unlicensed frequency spectrum, the WLAN STAs 952 and/or the WLAN AP 950 may perform a clear channel assessment (CCA) or listen before talk (LBT) procedure prior to communicating in order to determine whether the channel is available. In some examples, the wireless communications system 900 can include devices (e.g., UEs, etc.) that communicate with one or more UEs 904, base stations 902, APs 950, etc. utilizing the ultra-wideband (UWB) spectrum. The UWB spectrum can range from 3.1 to 10.5 GHz.

The small cell base station 902′ may operate in a licensed and/or an unlicensed frequency spectrum. When operating in an unlicensed frequency spectrum, the small cell base station 902′ may employ LTE or NR technology and use the same 5 GHz unlicensed frequency spectrum as used by the WLAN AP 950. The small cell base station 902′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 900 may further include a millimeter wave (mmW) base station 980 that may operate in mmW frequencies and/or near mmW frequencies in communication with a UE 982. The mmW base station 980 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 900 millimeters. The super high frequency (SHF) band extends between 3 GHz and 30 GHz, also referred to as centimeter wave. Communications using the mmW and/or near mmW radio frequency band have high path loss and a relatively short range. The mmW base station 980 and the UE 982 may utilize beamforming (transmit and/or receive) over an mmW communication link 984 to compensate for the extremely high path loss and short range. Further, it will be appreciated that in alternative configurations, one or more base stations 902 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 902/980, UEs 904/982) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 904/982 and the cell in which the UE 904/982 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 904 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 904/982 in a cell may have different downlink primary carriers. The same is true for the uplink primary carriers. The network is able to change the primary carrier of any UE 904/982 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 9, one of the frequencies utilized by the macro cell base stations 902 may be an anchor carrier (or “PCell”) and other frequencies utilized by the macro cell base stations 902 and/or the mmW base station 980 may be secondary carriers (“SCells”). In carrier aggregation, the base stations 902 and/or the UEs 904 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 904/982 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 902 and/or a UE 904 can be equipped with multiple receivers and/or transmitters. For example, a UE 904 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 904 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 904 is being served in band ‘X’ or band ‘Y,’ because of the separate “Receiver 2,” the UE 904 can measure band ‘Z’ without interrupting the service on band ‘X’ or band ‘Y.’

The wireless communications system 900 may further include a UE 964 that may communicate with a macro cell base station 902 over a communication link 920 and/or the mmW base station 980 over an mmW communication link 984. For example, the macro cell base station 902 may support a PCell and one or more SCells for the UE 964 and the mmW base station 980 may support one or more SCells for the UE 964.

The wireless communications system 900 may further include one or more UEs, such as UE 990, that connects indirectly to one or more communication networks via one or more device-to-device (D2D) peer-to-peer (P2P) links (referred to as “sidelinks”). In the example of FIG. 9, UE 990 has a D2D P2P link 992 with one of the UEs 904 connected to one of the base stations 902 (e.g., through which UE 990 may indirectly obtain cellular connectivity) and a D2D P2P link 994 with WLAN STA 952 connected to the WLAN AP 950 (through which UE 990 may indirectly obtain WLAN-based Internet connectivity). In an example, the D2D P2P links 992 and 994 may be supported with any well-known D2D RAT, such as LTE Direct (LTE-D), Wi-Fi Direct (Wi-Fi-D), Bluetooth®, and so on.

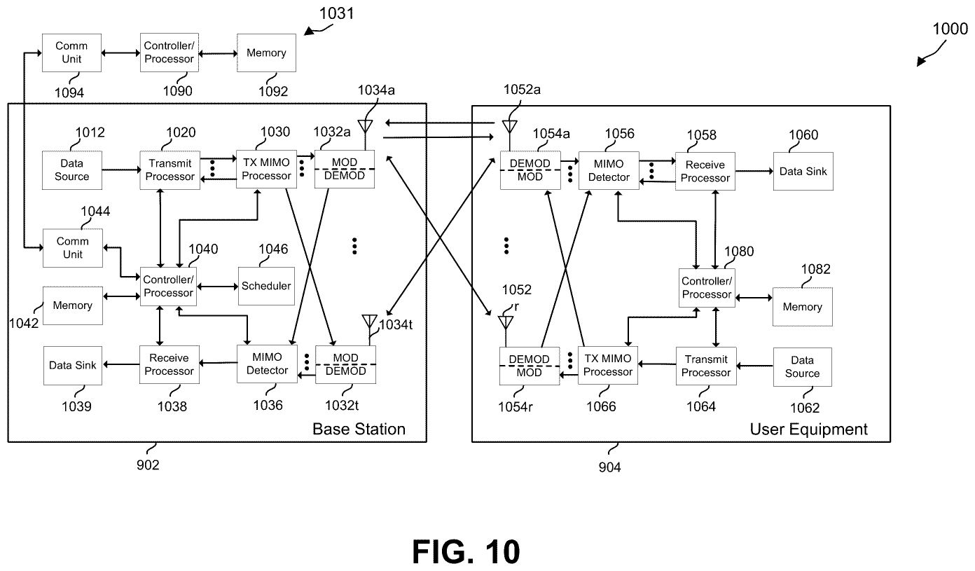

FIG. 10 shows a block diagram of a design of a base station 902 and a UE 904 that enable transmission and processing of signals exchanged between the UE and the base station, in accordance with some aspects of the present disclosure. Design 1000 includes components of a base station 902 and a UE 904, which may be one of the base stations 902 and one of the UEs 904 in FIG. 9. Base station 902 may be equipped with T antennas 1034a through 1034t, and UE 904 may be equipped with R antennas 1052a through 1052r, where in general T≥1 and R≥1.

At base station 902, a transmit processor 1020 may receive data from a data source 1012 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 1020 may also process system information (e.g., for semi-static resource partitioning information (SRPI) and/or the like) and control information (e.g., CQI requests, grants, upper layer signaling, and/or the like) and provide overhead symbols and control symbols. Transmit processor 1020 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 1030 may perform spatial processing (e.g., precoding) on the data symbols, the control symbols, the overhead symbols, and/or the reference symbols, if applicable, and may provide T output symbol streams to T modulators (MODs) 1032a through 1032t. The modulators 1032a through 1032t are shown as a combined modulator-demodulator (MOD-DEMOD). In some cases, the modulators and demodulators can be separate components. Each modulator of the modulators 1032a to 1032t may process a respective output symbol stream (e.g., for an orthogonal frequency-division multiplexing (OFDM) scheme and/or the like), to obtain an output sample stream. Each modulator of the modulators 1032a to 1032t may further process (e.g., convert to analog, amplify, filter, and upconvert) the output sample stream to obtain a downlink signal. T downlink signals may be transmitted from modulators 1032a to 1032t via T antennas 1034a through 1034t, respectively. According to certain aspects described in more detail below, the synchronization signals can be generated with location encoding to convey additional information.

At UE 904, antennas 1052a through 1052r may receive the downlink signals from base station 902 and/or other base stations and may provide received signals to demodulators (DEMODs) 1054a through 1054r, respectively. The demodulators 1054a through 1054r are shown as a combined modulator-demodulator (MOD-DEMOD). In some cases, the modulators and demodulators can be separate components. Each demodulator of the demodulators 1054a through 1054r may condition (e.g., filter, amplify, downconvert, and digitize) a received signal to obtain input samples. Each demodulator of the demodulators 1054a through 1054r may further process the input samples (e.g., for OFDM and/or the like) to obtain received symbols. A MIMO detector 1056 may obtain received symbols from all R demodulators 1054a through 1054r, perform MIMO detection on the received symbols if applicable, and provide detected symbols. A receive processor 1058 may process (e.g., demodulate and decode) the detected symbols, provide decoded data for UE 904 to a data sink 1060, and provide decoded control information and system information to a controller/processor 1080. A channel processor may determine reference signal received power (RSRP), received signal strength indicator (RSSI), reference signal received quality (RSRQ), channel quality indicator (CQI), and/or the like.

On the uplink, at UE 904, a transmit processor 1064 may receive and process data from a data source 1062 and control information (e.g., for reports comprising RSRP, RSSI, RSRQ, CQI, and/or the like) from controller/processor 1080. Transmit processor 1064 may also generate reference symbols for one or more reference signals (e.g., based at least in part on a beta value or a set of beta values associated with the one or more reference signals). The symbols from transmit processor 1064 may be precoded by a TX-MIMO processor 1066 if application, further processed by modulators 1054a through 1054r (e.g., for DFT-s-OFDM, CP-OFDM, and/or the like), and transmitted to base station 902. At base station 902, the uplink signals from UE 904 and other UEs may be received by antennas 1034a through 1034t, processed by demodulators 1032a through 1032t, detected by a MIMO detector 1036 if applicable, and further processed by a receive processor 1038 to obtain decoded data and control information sent by UE 904. Receive processor 1038 may provide the decoded data to a data sink 1039 and the decoded control information to controller (processor) 1040. Base station 902 may include communication unit 1044 and communicate to a network controller 1031 via communication unit 1044. Network controller 1031 may include communication unit 1094, controller/processor 1090, and memory 1092.

In some aspects, one or more components of UE 904 may be included in a housing. Controller 1040 of base station 902, controller/processor 1080 of UE 904, and/or any other component(s) of FIG. 10 may perform one or more techniques associated with implicit UCI beta value determination for NR.

Memories 1042 and 1082 may store data and program codes for the base station 902 and the UE 904, respectively. A scheduler 1046 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 11 shows a diagram illustrating an example disaggregated base station 1100 architecture. The disaggregated base station 1100 architecture may include one or more central units (CUs) 1110 that can communicate directly with a core network 1120 via a backhaul link, or indirectly with the core network 1120 through one or more disaggregated base station units (such as a Near-Real Time (Near-RT) RAN Intelligent Controller (RIC) 1125 via an E2 link, or a Non-Real Time (Non-RT) RIC 1115 associated with a Service Management and Orchestration (SMO) Framework 1105, or both). A CU 1110 may communicate with one or more distributed units (DUs) 1130 via respective midhaul links, such as an F1 interface. The DUs 1130 may communicate with one or more radio units (RUs) 1140 via respective fronthaul links. The RUs 1140 may communicate with respective UEs 904 via one or more radio frequency (RF) access links. In some implementations, the UE 904 may be simultaneously served by multiple RUs 1140.

Each of the units (e.g., the CUs 1110, the DUs 1130, the RUs 1140, as well as the Near-RT RICs 1125, the Non-RT RICs 1115 and the SMO Framework 1105) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1110. The CU 1110 may be configured to handle user plane functionality (i.e., Central Unit—User Plane (CU-UP)), control plane functionality (i.e., Central Unit—Control Plane (CU-CP)), or a combination thereof. In some implementations, the CU 1110 can be logically split into one or more CU-UP units and one or more CU-CP units. The CU-UP unit can communicate bidirectionally with the CU-CP unit via an interface, such as the E1 interface when implemented in an O-RAN configuration. The CU 1110 can be implemented to communicate with the DU 1130, as necessary, for network control and signaling.

The DU 1130 may correspond to a logical unit that includes one or more base station functions to control the operation of one or more RUs 1140. In some aspects, the DU 1130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1130 may further host one or more low PHY layers. Each layer (or module) can be implemented with an interface configured to communicate signals with other layers (and modules) hosted by the DU 1130, or with the control functions hosted by the CU 1110.

Lower-layer functionality can be implemented by one or more RUs 1140. In some deployments, an RU 1140, controlled by a DU 1130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1140 can be implemented to handle over the air (OTA) communication with one or more UEs 904. In some implementations, real-time and non-real-time aspects of control and user plane communication with the RU(s) 1140 can be controlled by the corresponding DU 1130. In some scenarios, this configuration can enable the DU(s) 1130 and the CU 1110 to be implemented in a cloud-based RAN architecture, such as a vRAN architecture.

The SMO Framework 1105 may be configured to support RAN deployment and provisioning of non-virtualized and virtualized network elements. For non-virtualized network elements, the SMO Framework 1105 may be configured to support the deployment of dedicated physical resources for RAN coverage requirements which may be managed via an operations and maintenance interface (such as an O1 interface). For virtualized network elements, the SMO Framework 1105 may be configured to interact with a cloud computing platform (such as an open cloud (O-Cloud) 1190) to perform network element life cycle management (such as to instantiate virtualized network elements) via a cloud computing platform interface (such as an 02 interface). Such virtualized network elements can include, but are not limited to, CUs 1110, DUs 1130, RUs 1140 and Near-RT RICs 1125. In some implementations, the SMO Framework 1105 can communicate with a hardware aspect of a 4G RAN, such as an open eNB (O-eNB) 1111, via an O1 interface. Additionally, in some implementations, the SMO Framework 1105 can communicate directly with one or more RUs 1140 via an O1 interface. The SMO Framework 1105 also may include a Non-RT RIC 1115 configured to support functionality of the SMO Framework 1105.

The Non-RT RIC 1115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1125. The Non-RT RIC 1115 may be coupled to or communicate with (such as via an A1 interface) the Near-RT RIC 1125. The Near-RT RIC 1125 may be configured to include a logical function that enables near-real-time control and optimization of RAN elements and resources via data collection and actions over an interface (such as via an E2 interface) connecting one or more CUs 1110, one or more DUs 1130, or both, as well as an O-eNB, with the Near-RT RIC 1125.

In some implementations, to generate AI/ML models to be deployed in the Near-RT RIC 1125, the Non-RT RIC 1115 may receive parameters or external enrichment information from external servers. Such information may be utilized by the Near-RT RIC 1125 and may be received at the SMO Framework 1105 or the Non-RT RIC 1115 from non-network data sources or from network functions. In some examples, the Non-RT RIC 1115 or the Near-RT RIC 1125 may be configured to tune RAN behavior or performance. For example, the Non-RT RIC 1115 may monitor long-term trends and patterns for performance and employ AI/ML models to perform corrective actions through the SMO Framework 1105 (such as reconfiguration via O1) or via creation of RAN management policies (such as A1 policies).

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that communicatively couples various system components including system memory 1215, such as read-only memory (ROM) 1220 and random-access memory (RAM) 1225 to processor 1210. Computing system 1200 can include a cache 1212 of high-speed memory connected directly with, in close proximity to, or integrated as part of processor 1210.

Processor 1210 can include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., light detection and ranging (LIDAR) sensors, laser range finders, radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core), or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative Aspects of the Disclosure Include:

Aspect 1. An apparatus for wireless communications, comprising: at least one memory; and at least one processor coupled to the at least one memory, the at least one processor configured to: receive a configuration message, wherein the configuration message comprises time-gap information associated with a control signal; receive the control signal, wherein the control signal comprises radio resource information associated with a sensing signal; receive the sensing signal, wherein the sensing signal comprises one or more reflected waveforms associated with a detected object; and transmit a measurement report corresponding with the detected object.

Aspect 2. The apparatus of Aspect 1, wherein, to receive the control signal, the at least one processor is configured to: initiate monitoring for the sensing signal based on the time-gap information.

Aspect 3. The apparatus of any of Aspects 1 to 2, wherein the at least one processor is configured to initiate the monitoring for the sensing signal after a duration specified by the time-gap information.

Aspect 4. The apparatus of any of Aspects 1 to 3, wherein the configuration message further comprises radio resource information associated with the control signal.

Aspect 5. The apparatus of any of Aspects 1 to 4, wherein the configuration message comprises a radio network temporary identifier (RNTI) associated with the control signal.

Aspect 6. The apparatus of any of Aspects 1 to 5, wherein the control signal is transmitted via Downlink Control Information (DCI).

Aspect 7. The apparatus of any of Aspects 1 to 6, wherein the radio resource information comprises orthogonal frequency-division multiplexing (OFDM) waveform information, frequency-modulated continuous-wave (FMCW) waveform information, periodicity information, sequencing information, or a combination thereof.

Aspect 8. The apparatus of any of Aspects 1 to 7, wherein the control signal comprise uplink radio resource information associated with the measurement report.

Aspect 9. The apparatus of any of Aspects 1 to 8, wherein the measurement report comprises a distance metric for the detected object, a speed metric for the detected object, Doppler frequency information for the detected object, or a combination thereof.

Aspect 10. The apparatus of any of Aspects 1 to 9, wherein the measurement report comprises an adjustment suggestion message for the sensing signal, an adjustment suggestion for the control signal, or a combination thereof.

Aspect 11. The apparatus of any of Aspects 1 to 10, wherein the apparatus is configured as a user equipment (UE), and further comprising: a transceiver configured to receive the configuration message, receive the control signal, receive the sensing signal, and transmit the measurement report.

Aspect 12. A method for wireless communications at a user equipment (UE), comprising: receiving, at the UE, a configuration message, wherein the configuration message comprises time-gap information associated with a control signal; receiving, at the UE, the control signal, wherein the control signal comprises radio resource information associated with a sensing signal; receiving, at the UE, the sensing signal, wherein the sensing signal comprises one or more reflected waveforms associated with a detected object; and transmitting a measurement report corresponding with the detected object.

Aspect 13. The method of Aspect 12, wherein receiving the control signal further comprises: initiating monitoring for the sensing signal based on the time-gap information.

1. An apparatus for wireless communications, comprising:
at least one memory; and
at least one processor coupled to the at least one memory, the at least one processor configured to:
receive a configuration message, wherein the configuration message comprises time-gap information associated with a control signal;
receive the control signal, wherein the control signal comprises radio resource information associated with a sensing signal;
receive the sensing signal, wherein the sensing signal comprises one or more reflected waveforms associated with a detected object; and
transmit a measurement report corresponding with the detected object.

2. The apparatus of claim 1, wherein, to receive the control signal, the at least one processor is configured to:
initiate monitoring for the sensing signal based on the time-gap information.

3. The apparatus of claim 2, wherein the at least one processor is configured to initiate the monitoring for the sensing signal after a duration specified by the time-gap information.

4. The apparatus of claim 1, wherein the configuration message further comprises radio resource information associated with the control signal.

5. The apparatus of claim 4, wherein the configuration message comprises a radio network temporary identifier (RNTI) associated with the control signal.

6. The apparatus of claim 1, wherein the control signal is transmitted via Downlink Control Information (DCI).

7. The apparatus of claim 1, wherein the radio resource information comprises orthogonal frequency-division multiplexing (OFDM) waveform information, frequency-modulated continuous-wave (FMCW) waveform information, periodicity information, sequencing information, or a combination thereof.

8. The apparatus of claim 1, wherein the control signal comprise uplink radio resource information associated with the measurement report.

9. The apparatus of claim 1, wherein the measurement report comprises a distance metric for the detected object, a speed metric for the detected object, Doppler frequency information for the detected object, or a combination thereof.

10. The apparatus of claim 1, wherein the measurement report comprises an adjustment suggestion message for the sensing signal, an adjustment suggestion for the control signal, or a combination thereof.

11. The apparatus of claim 1, wherein the apparatus is configured as a user equipment (UE), and further comprising:
a transceiver configured to receive the configuration message, receive the control signal, receive the sensing signal, and transmit the measurement report.

12. A method for wireless communications at a user equipment (UE), comprising:
receiving, at the UE, a configuration message, wherein the configuration message comprises time-gap information associated with a control signal;
receiving, at the UE, the control signal, wherein the control signal comprises radio resource information associated with a sensing signal;
receiving, at the UE, the sensing signal, wherein the sensing signal comprises one or more reflected waveforms associated with a detected object; and
transmitting a measurement report corresponding with the detected object.

13. The method of claim 12, wherein receiving the control signal further comprises:
initiating monitoring for the sensing signal based on the time-gap information.

14. The method of claim 13, wherein monitoring for the sensing signal is initiated after a duration specified by the time-gap information.

15. The method of claim 12, wherein the configuration message further comprises radio resource information associated with the control signal.

16. (canceled)

17. The method of claim 12, wherein the control signal is transmitted via Downlink Control Information (DCI).

18. The method of claim 12, wherein the radio resource information comprises orthogonal frequency-division multiplexing (OFDM) waveform information, frequency-modulated continuous-wave (FMCW) waveform information, periodicity information, sequencing information, or a combination thereof.

19. The method of claim 12, wherein the control signal comprise uplink radio resource information associated with the measurement report.

20. The method of claim 12, wherein the measurement report comprises a distance metric for the detected object, a speed metric for the detected object, Doppler frequency information for the detected object, or a combination thereof.

21. The method of claim 12, wherein the measurement report comprises an adjustment suggestion message for the sensing signal, an adjustment suggestion for the control signal, or a combination thereof.

22-30. (canceled)
